(19) United States
(12) Patent Application Publication
(10) Pub. No.: US 2007/0062380 A1
(43) Pub. Date: Mar. 22, 2007

(54) CRUST FREEZING SYSTEM

(75) Inventors: Andrew A. Landis, Telford, PA (US); Todd A. Freed, Schwenksville, PA (US); Mark D. Leer, Harleysville, PA (US); T. Edward Kilburn, Pennsburg, PA (US); Michael D. Newman, Hillsborough, NJ (US); D. Scott Boyles, Telford, PA (US)

Correspondence Address: THE BOC GROUP, INC., 575 MOUNTAIN AVENUE, MURRAY HILL, NJ, 07974-2064, US

(73) Assignee: The BOC Group, Inc.

(21) Appl. No.: 11/461,828

(22) Filed: Aug. 2, 2006

Related U.S. Application Data
(60) Provisional application No. 60/705,229, filed on Aug. 3, 2005.

(51) Int. Cl. A23B 4/00

(52) U.S. Cl. 99/517

(57) ABSTRACT

This invention is directed to a system for cooling a product comprising an insulated housing; a cooling means inside the housing for cooling the product so as to establish a cooling zone inside the housing; and a transport assembly inside the housing adapted for continuously transporting the product to be cooled into and out of the cooling zone, the assembly comprising an inlet assembly for delivering food products for processing, an outlet assembly for discharging food products for subsequent processing, an intermediate assembly disposed for coaction with the inlet assembly and the outlet assembly to provide a processing zone without suspending movement of the inlet assembly and the outlet assembly.

### FIELD OF THE INVENTION

The present invention relates to a system, apparatus and method for chilling food products. In particular, this invention relates to processing food products as in freezing the surface layers of food products for subsequent processing.

### BACKGROUND OF THE INVENTION

Prevention of food poisoning is of paramount importance in the food processing industry. Concern for food safety has lead most countries to regulate the food industry heavily to minimize public health risks. Despite these efforts, food poisoning still occurs. Many instances of food poisoning are attributed to spoiled food, which comes about when food products are left at a temperature conducive for bacterial growth.

Processed meats, such as sausages and deli meats, are usually microbial decontaminated during the cooking or smoking process. It is generally assumed that the cooking product remains free of microorganisms during the microorganisms during the subsequent decasing, slicing and packaging stages. Because outbreaks of food poisoning associated with these precooked food products still occur, it is believed that the cooked food is recontaminated with pathogenic bacteria in the food processing process.

One way to minimize the occurrence of recontamination during food processing is by minimizing the exposure of the food product to the temperature conductive to bacterial growth.

The present invention provides for a new and improved system, apparatus and method for treating food products which overcomes the above-referenced problems.

### SUMMARY OF THE INVENTION

An embodiment of this invention is directed to a system for cooling a product comprising an insulated housing; a cooling means inside the housing for cooling the product so as to establish a cooling zone inside the housing; and a transport assembly inside the housing adapted for continuously transporting the product to be cooled into and out of the cooling zone, the assembly comprising an inlet assembly for delivering food products for processing, an outlet assembly for discharging food products for subsequent processing, an intermediate assembly disposed for coaction with the inlet assembly and the outlet assembly to provide a processing zone without suspending movement of the inlet assembly and the outlet assembly.

Another embodiment of this invention is directed to an apparatus for processing a food product, the apparatus comprising a transport assembly inside a housing adapted for continuously transporting the product to be cooled into and out of a cooling zone within the housing, the assembly comprising an inlet assembly for delivering food products for processing, an outlet assembly for discharging food products for subsequent processing, an intermediate assembly disposed for coaction with the inlet assembly and the outlet assembly to provide a processing zone without suspending movement of the inlet assembly and the outlet assembly.

Another embodiment of this invention is directed to a method for cooling a product comprising providing a transport assembly inside a housing adapted for continuously transporting the product to be cooled into and out of the cooling zone, the assembly comprising an inlet assembly for delivering food products for processing, an outlet assembly for discharging food products for subsequent processing, an intermediate assembly disposed for coaction with the inlet assembly and the outlet assembly to provide a processing zone without suspending movement of the inlet assembly and the outlet assembly; delivering the product to the inlet assembly for processing; cooling the product in the cooling zone; and removing the product from the outlet assembly.

The cooling means comprises a flow of mechanical refrigeration selected from cryogen or other cold gases. A gas directing means to direct the mechanical refrigeration onto the product.

The inlet assembly comprises at least a lift mechanism, plug, and carriage. The intermediate assembly comprises at least one product carriage. The outlet assembly comprises at least a lift mechanism, plug and carriage.

### BRIEF DESCRIPTION OF THE DRAWINGS

The invention will be described in detail in the following description of preferred embodiments with reference to the following figures wherein:

FIGS. 1-5 show an apparatus of the present invention for processing food products;

FIG. 6 shows the apparatus of the present invention connected for coaction with a subsequent processing apparatus; and

FIG. 7 shows carriage and lift conveyor features of the apparatus according to the present invention.

### DESCRIPTION OF THE PREFERRED EMBODIMENTS

The present invention includes a transport mechanism adapted to transport the food product for cooling, particularly crust freezing, and to provide a cooling zone for the food product without interrupting the transport mechanism and movement of subsequent food products proceeding through the apparatus for processing.

The present invention also includes an apparatus that is adapted to be releasably engaged to a subsequent processing apparatus such as for example a slicer, peeler, etc., thereby reducing the necessary manpower for processing of a food product and to facilitate a seamless processing for the food product.

In this invention, cross flow of cryogen gas (CO₂, nitrogen, or a combination of both) is preferably parallel to the longitudinal axis of the deli logs or food products being frozen. Chilled air for freezing during mechanical refrigeration applications can also be used having a similar cross flow or alternatively, the chilled air can be introduced without a predetermined flow for freezing.

In an embodiment of this invention, the cryo-crusting area formed by the transport mechanism is pressurized due to the high volumetric cross-flow of the cryogen gas introduced to that area or cooling zone of the freezer.

In an embodiment, the system discharges an entire batch at once, and such discharge can be combined, even synchronized with a subsequent processing assembly, such as a slicer, peeler or UV sterilizer, integrated with the system. For the sake of brevity, such assemblies will be referred to, for example, as a “processor”.

In an embodiment, the footprint of the system, and in particular the width, conforms to the width of the processor to which the apparatus is integrated.

In an embodiment, the apparatus can be portable, i.e., designed with skids or rollers so that the system can be removed to a remote location for use, maintenance and/or repair.

The apparatus according to the present invention operates as follows. As in an embodiment of the present invention, the food product is formed as deli of food logs, and hereinafter referred to as “product”, are loaded either manually or by some other conveyor apparatus onto the load table for introduction into the apparatus. The product is transferred by the entry lift product carriage to be moved into the cooling zone of the apparatus. A cooling zone employs high velocity cross flow of cryogen preferably parallel to a longitudinal axis of the product log to facilitate crust freezing of same. In addition, the freezing zone is pressurized due to the high volumetric cross flow. Concurrent with the freezing of the product log, other product logs are being loaded and indexed for delivery to the freezing zone and during and upon arrival at such zone, the preceding product logs which have already been cooled, and in certain embodiments crust frozen, are being transferred to an outlet of the apparatus to be discharged or for packaging or entry to the processor. Indexing is the process by which a plurality or batch of product, such as deli logs, are loaded in an array with predetermined spacing for transport through the apparatus of the invention. The spacing of the deli logs is preferably equal between and among the deli logs.

The apparatus of the present invention may also include a control system connected to the processor, such as the slicer, so that the crust freezing temperature and/or gas flow velocities in the apparatus are controlled to be at a select temperature and the product exposed for a predetermined residence time for freezing to facilitate the subsequent slicing speed necessary.

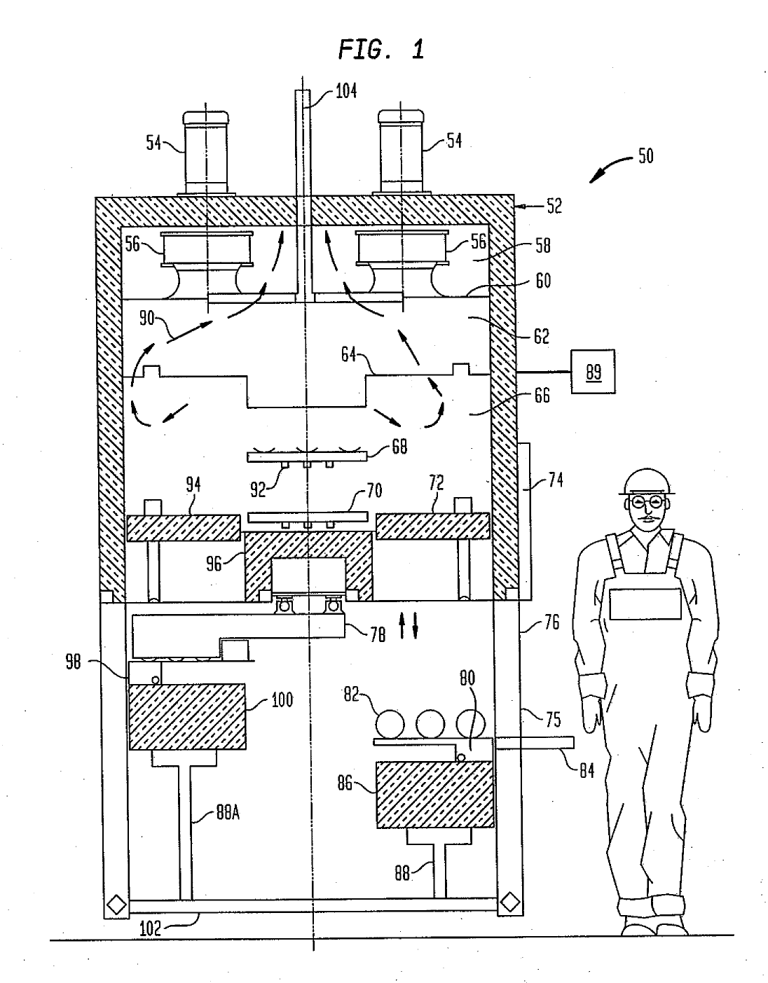

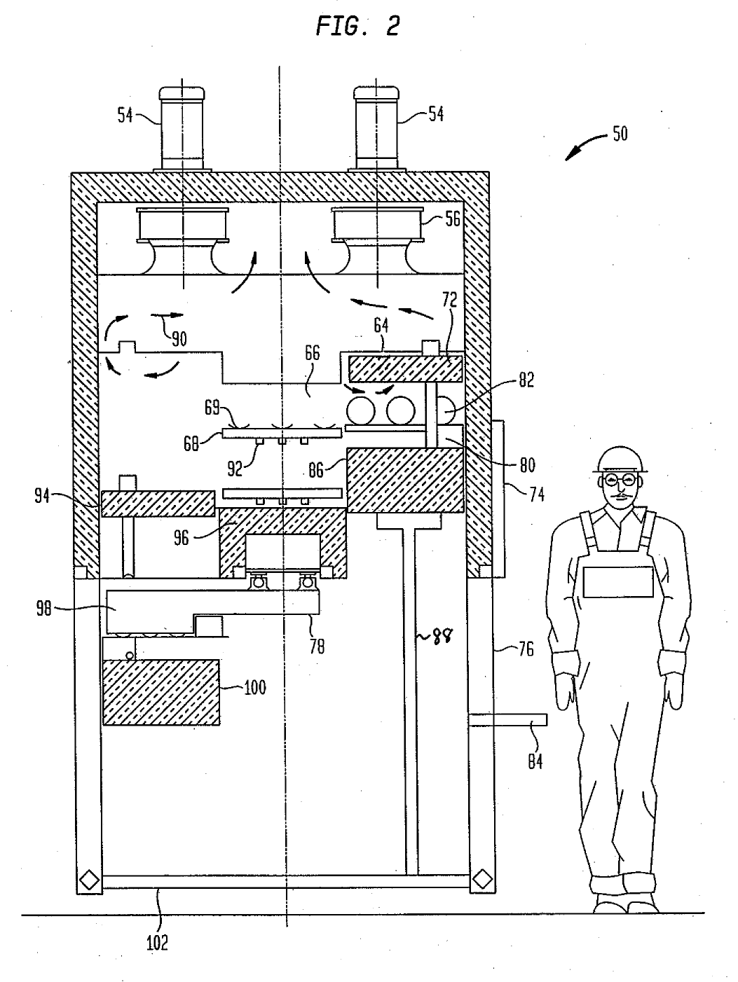

In the figures, particularly referring to FIGS. 1 and 2, an apparatus 50 of the present invention is shown generally. The apparatus 50 includes a housing 52 constructed and arranged for disposition on a plant or manufacturing floor. At least one motor 54 is positioned at the housing and connected to at least one fan 56 or a plurality of fans disposed inside the housing 52 to provide a high pressure region 58. Baffles 60, 64 are disposed in the housing 52 to provide a low pressure region 62 at an interior of the housing 52. A high pressure region 66 is also provided within housing 52 and this region 66 may also be referred to as the freezing chamber 66. The high pressure region 66 is formed by the baffle 64 operatively associated with other elements of the present invention discussed below. A safety door 74 provides access to an interior of the housing 52. A frame 76 includes support flooring 102 to support and provide structural integrity to the housing 52.

Product 82 to be frozen, and preferably crust frozen, is loaded on an entry lift product carriage 80 which is supported by an entry lift plug 86. Upon actuation, a lift mechanism 88 moves the entry lift plug 86 having the entry lift product carriage disposed thereon upward to a position shown in FIG. 2. Upon engagement of the entry lift product carriage 80 with an entry plug 72, both the entry plug 72 and the entry lift product carriage 80 will preferably move together in a mechanically integrated manner as a single unit as shown, for example, in FIG. 2.

In FIG. 2, the entry lift plug 86 has effectively sealed an inlet of the high pressure region 66 while an exit plug 94 seals an outlet of the high pressure region 66. A table member 96 is provided in the housing 52, and constructed and arrange to coact with the plugs 86, 94 to seal the freezing zone 66. Chilling and freezing of the product 82 commences at this stage in the high pressure region 66.

The upper product carriage 68 is positioned to coact with the entry lift product carriage 80, thereby retaining the product 80, still being chilled, on the upper product carriage 68. The upper product carriage 68 and the entry lift product carriage 80 may be formed with troughs 69 to receive the product 82. The coaction of the upper product carriage 68 and the entry lift product carriage 80 is then facilitated.

The upper product carriage 68 moves in a reversible direction back to a central area of the high pressure region 66 with the product 82 disposed thereon, thereby removing from the entry lift product carriage 80 the product 82 so that carriage 80 can return to be lowered into the originating position to retrieve more product by the lift mechanism 88. The originating product 82 disposed upon the upper product carriage 68 undergoes full cooling, while the new product may be introduced into the apparatus 50 at a load table 84. The cooling may be freezing a portion or a substantial part of the food product. The new product 82A arriving on the entry lift product carriage 80 into the high pressure region 66, which is the cooling zone. In an embodiment, the food product may be crust frozen while the product 82 is still undergoing cooling.

Lift mechanism 88 has elevated the entry lift plug 86 to a position sufficient to maintain the freezing chamber 66 in a sealed condition, while the newly entered product 82A has not been elevated as far into the freezing zone 66.

Lower product carriage 70 moves into position to coact with the entry lift product carriage 80 so that when the entry lift product carriage 80. New product 82A may be retained on the lower product carriage 70 and thereby transferred back into the center of the freezing zone 66.

It should be noted at this stage that the entry lift plug 86 and the entry plug 72 coact to continuously maintain the freezing zone 66 chamber in a sealed condition so that a plurality of new food products 82A can be introduced into the freezing zone 66 while the product 82, earlier introduced to the freezing zone 66, can continue to be frozen.

The upper product carriage 68 and the lower product carriage 70 are disposed at substantially a central portion of the freezing zone 66, while the entry lift product carriage 80 may be lowered by the lift mechanism 88 to receive a subsequent batch of product.

The apparatus 50 is constructed with a controller 89 connected by the apparatus 50 to control such movements such that the disposition of the entry lift product carriage 80 with respect to a load table 84 is monitored, thereby triggering a subsequent load of product if automatic conveyor means (not shown) is employed at an inlet 75 of the apparatus 50.

In addition, the controller 89 monitors coaction between the entry plug 72 and entry lift plug 86, the exit plug 94 and the exit lift plug 100 to ensure that coordination of movement of such elements provides for the freezing zone 66 being sealed during inlet of the product 82, 82A, cooling or freezing of product, outlet of product, and any transfer of product throughout these movements.

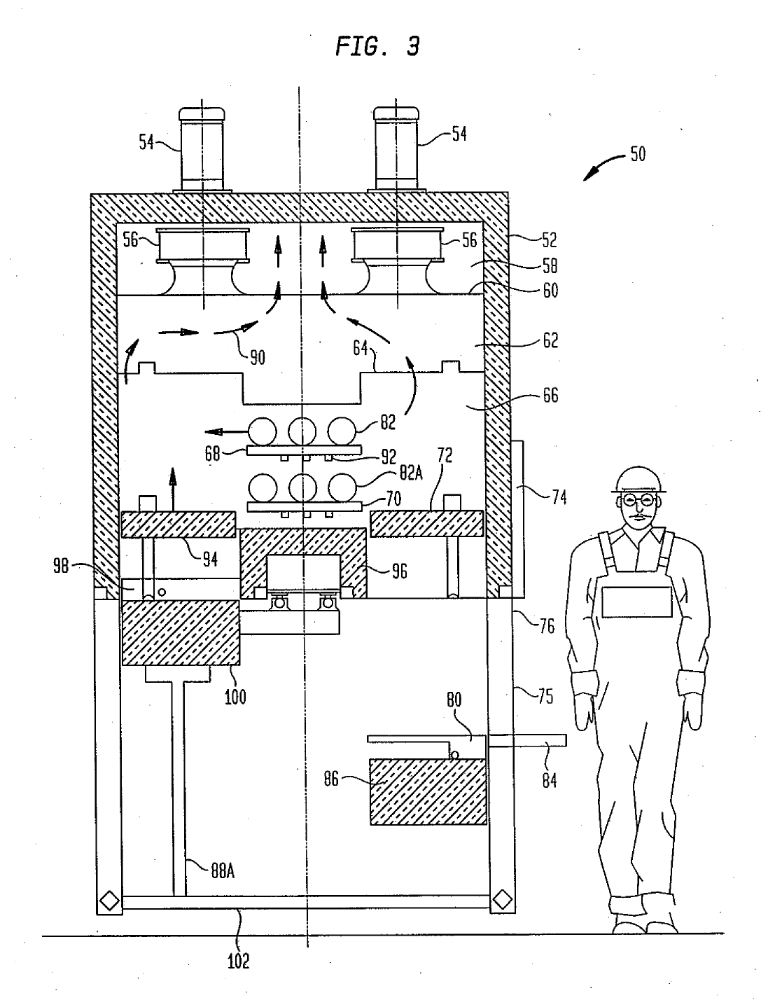

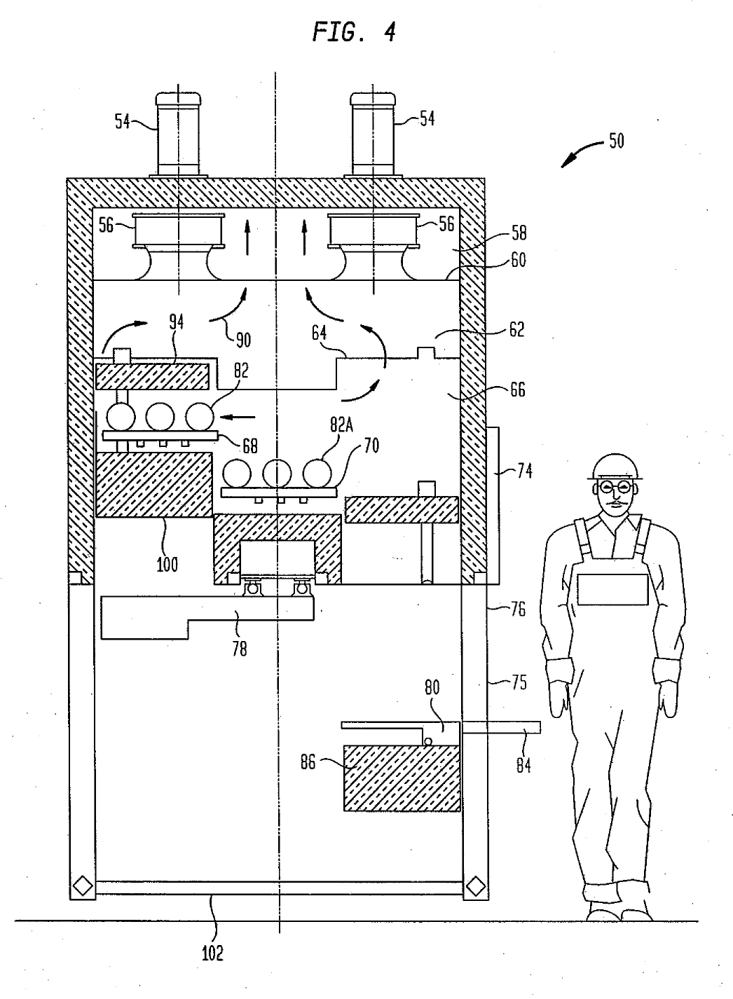

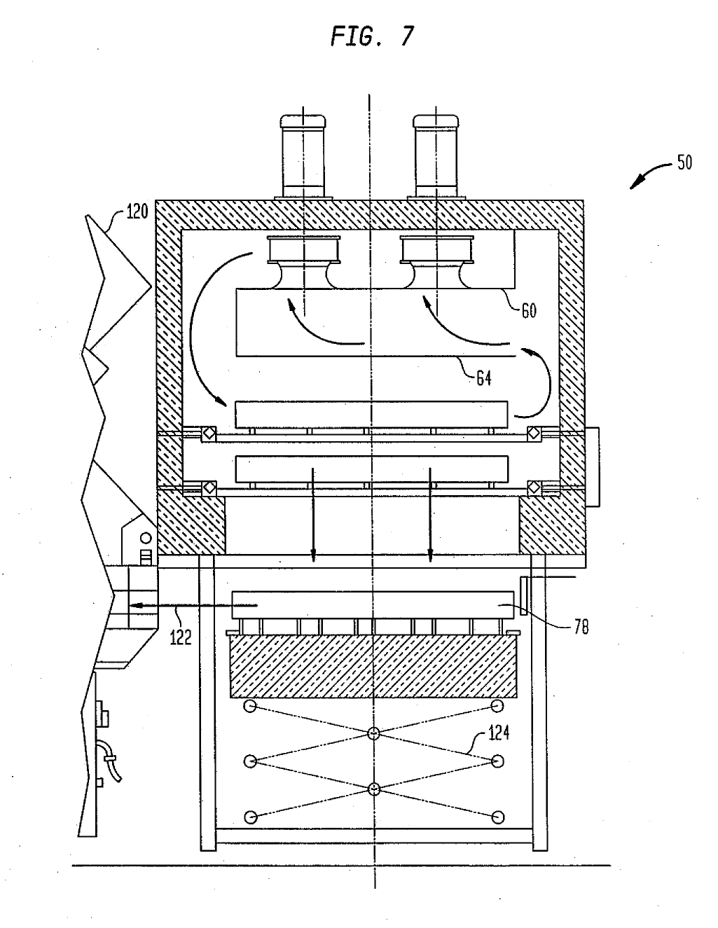

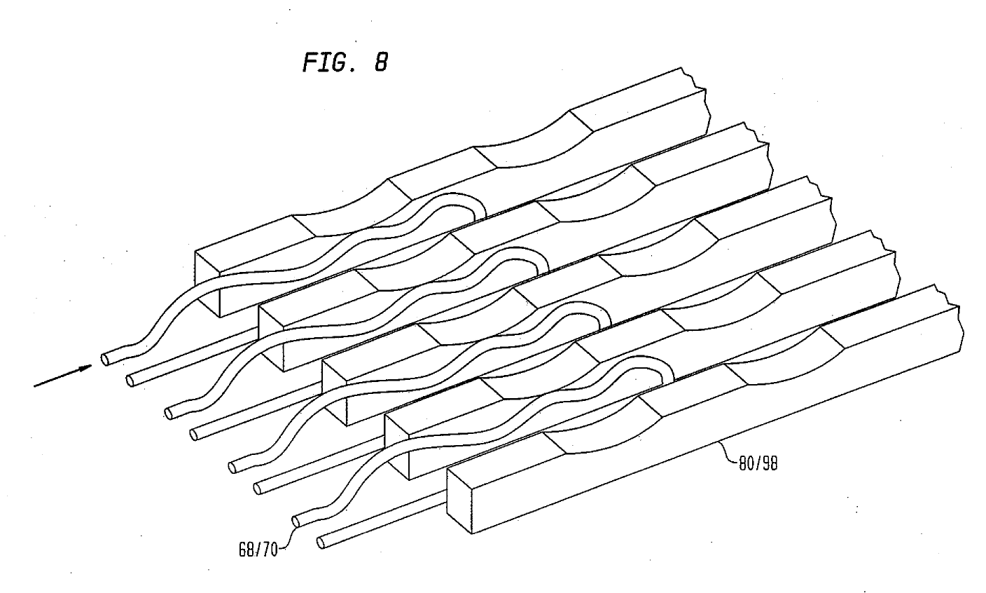

In the figures, particularly referring to FIGS. 3 and 4, the lift mechanism 88A has moved the exit lift plug 100 in an upright direction to coact with the exit plug 94 to continue to maintain the freezing zone 66 in a sealed condition. When the exit plug 94 has reached the upper most position, the upper product carriage 68 moves toward the exit lift product carriage 98 to coact therewith as shown in FIG. 7 and to be disposed beneath the exit plug 94. Thereafter, the upper product carriage 68 begins to move in a reverse direction thereby depositing the product 82 on the exit lift product carriage 98.

The upper product carriage 68 subsequently moves horizontally back to its center position thereby leaving the food products 82 on the exit lift product carriage 98. The exit lift product carriage 98 is slightly pitched in a direction downward toward an outlet of the apparatus 50 to facilitate transfer to the subsequent processor after the apparatus 50 processing. Therefore, a surface of the exit lift product carriage 98 has a relatively smooth planar surface to facilitate movement of the product 82, 82A from the apparatus 50.

The exit lift plug 100 with the product 82 may be lowered by the lift mechanism 88A and so too is the exit plug 94 to maintain the freezing zone 66 in a sealed condition.

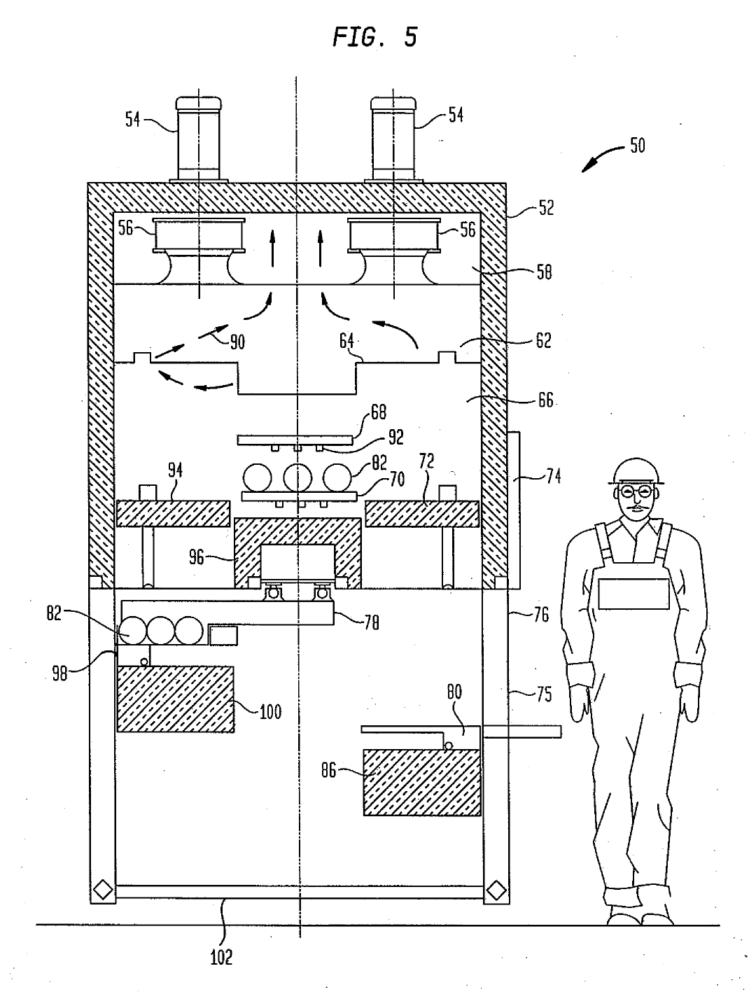

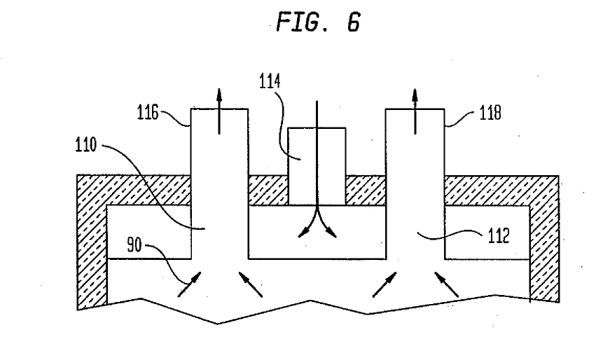

In FIG. 5, the exit lift product carriage 98 has withdrawn the product 82 from the freezing zone 66, while the exit plug 94 in conjunction with the entry plug 72 maintains the sealed condition of the freezing zone 66. The product 82 may then be removed from the apparatus 50 by a pusher device 78 such that the product proceeds to further processing external of the apparatus 50.

The apparatus 50 proceeds to complete the freezing and remove the product 82A remaining on the lower product carriage 70 in a manner similar to that described with respect to the product 82 removed at the upper product carriage 68.

Supports 92, preferably formed of steel, are used to provide structural integrity to upper and lower product carriages 68, 70.

Referring to FIG. 1, cryogen coolant is introduced into the apparatus 50 by a pipe or tube 104 that extends through the housing 52 and the baffle 60 into the low pressure region 62 for providing the cryogen spray. The tube 104 is split into a plurality of branches. In one embodiment, two of the branches 106, 108 only are being shown due to the perspective of the figures. The branches 106, 108 provide for a uniform flow of cryogen into the low pressure region 62. The cryogen spray is circulated throughout the low and high pressure regions 62, 66 by the fans 56.

Referring to FIG. 1, the fans 56 provide for the air flow 90 as shown by the arrows to circulate the cryogen spray for freezing throughout the freezing zone 66 to cool the product 82, 82A. In an embodiment, the cooling of the product leads to crust freezing.

Also shown in FIG. 6 are the freezing connections or ducts 110, 112 for mechanical freezing, wherein optionally, the fans 56 of FIG. 1 are replaced with ducts 110, 112 in connection with a mechanical refrigeration unit (not shown) to introduce cryogen or other cold gases into the freezing zone 66 to displace warm air in the freezing zone and thereby cool the product 82, 82A. In certain embodiments of this invention, cooling leads to crust freezing of the product. The cold gas return 114 is connected to the refrigeration unit to return warmer gas displaced from the apparatus 50 at returns 116, 118.

FIG. 7 shows the apparatus 50 of the present invention connected to a subsequent processor apparatus 120 such as, for example, the slicer, peeler, etc. In this manner of construction, the apparatus 50 can cool the product 82, 82A as required, after which the product 82, 82A is transferred as indicated by arrow 122 from the exit lift product carriage 98 to be delivered to the subsequent processor 120. The pusher 78 of the apparatus 50 implements this transfer. FIG. 6 also shows an alternate mechanism of FIG. 1, i.e., the lift mechanism 88, 88A can instead consist of a telescoping or scissoring device 124.

FIG. 8 shows the construction of the entry lift product carriage 80, upper product carriage 68, lower product carriage 70 and the exit lift product carriage 98, and the coaction therebetween for transfer of the product to and from the freezing zone 66.

Because the system can be integrated with subsequent processors (slicers, peelers, UV assemblies, etc.), this obviates the need for a food handler to manually handle the processed food from the cooling system and transport the food product to the subsequent slicer, peeler, etc. This reduces manpower at the process line, promotes a safer processing environment, and facilitates a more hygienic processing of the food products.

One embodiment of this invention is directed to a system for cooling and preferably crust freezing a plurality of food products, comprising a transport assembly for transporting the food products to be cooled, the transport assembly adapted for containing a select number of food products for cooling without interrupting the transport of remaining food products to be cooled and which have already been cooled.

Another embodiment of this invention is directed to an apparatus for processing food products, comprising: transport means for transporting the food products for processing, the transport means constructed and arranged to provide a cooling zone for certain of the food products while continuing to transport others of the food products to and from the cooling zone.

Another embodiment of this invention is directed to a method of processing food products, comprising forming a process zone with a transport means for the food products without suspending movement of the transport means.

Yet another embodiment of the invention is directed to a method above wherein either a cryogenic gas or mechanical refrigeration cold air is provided to the process zone for chilling the food products.

Another embodiment of this invention is directed to a method above wherein the transport means comprises an inlet assembly for delivering food products for processing, an outlet assembly for discharging food products for subsequent processing, an intermediate assembly disposed for coaction with the inlet assembly and the outlet assembly to provide a processing zone without suspending movement of the inlet assembly and the outlet assembly.

In an embodiment, the processed batches of the product are subsequently removed from the process zone for discharge to further processing at, for example, a slicer, peeler, UV apparatus, etc.

In another embodiment, the method of processing food products, comprising forming a processing zone for the food products with a transport means to transport the food products to and from the processing zone.

Another embodiment of this invention is directed to a method of processing food products, comprising transporting food products with respect to a process zone for the food products, and forming the processing zone with means for transporting the food products to and from the processing zone.

Another embodiment of this invention is directed to a method above which further comprises providing cryogenic gas or cold air to the processing zone. The method above wherein the processing zone is freezing zone.

Because the system can be integrated with subsequent processors (slicers, peelers, UV assemblies, etc.), an embodiment of this invention obviates the need for a food handler to manually handle the processed food from the invention and transport the food product to the subsequent slicer, peeler, etc. This reduces manpower at the process line, promotes a safer processing environment, and facilitates a more hygienic processing of the food products.

It will be understood that the embodiments described herein are merely exemplary and that a person skilled in the art may make many variations and modifications without departing from the spirit and scope of the invention. All such modifications and variations are intended to be included within the scope of the invention as described herein. It should be understood that embodiments described above are not only in the alternative, but may also be combined.

What is claimed is:

1. A system for cooling a product comprising
an insulated housing;
a cooling means inside the housing for cooling the product so as to establish a cooling zone inside the housing; and
a transport assembly inside the housing adapted for continuously transporting the product to be cooled into and out of the cooling zone, the assembly comprising an inlet assembly for delivering food products for processing, an outlet assembly for discharging food products for subsequent processing, an intermediate assembly disposed for coaction with the inlet assembly and the outlet assembly to provide a processing zone without suspending movement of the inlet assembly and the outlet assembly.

2. The system of claim 1 wherein the cooling means comprises a flow of mechanical refrigeration selected from cryogen or other cold gases.

3. The system of claim 2 further comprises an arrangement of gas directing means to direct the mechanical refrigeration onto the product.

4. The system of claim 1 wherein the inlet assembly comprises at least a lift mechanism, plug, and carriage.

5. The system of claim 1 wherein the intermediate assembly comprises at least one product carriage.

6. The system of claim 1 wherein the outlet assembly comprises at least a lift mechanism, plug and carriage.

7. The system of claim 1 wherein the product is a food product.

8. An apparatus for processing a food product, the apparatus comprising a transport assembly inside a housing adapted for continuously transporting the product to be cooled into and out of a cooling zone within the housing, the assembly comprising an inlet assembly for delivering food products for processing, an outlet assembly for discharging food products for subsequent processing, an intermediate assembly disposed for coaction with the inlet assembly and the outlet assembly to provide a processing zone without suspending movement of the inlet assembly and the outlet assembly.

9. The apparatus of claim 8 wherein the inlet assembly comprises at least a lift mechanism, plug, and carriage.

10. The apparatus of claim 8 wherein the intermediate assembly comprises at least one product carriage.

11. The apparatus of claim 8 wherein the outlet assembly comprises at least a lift mechanism, plug and carriage.

12. The apparatus of claim 8 further comprising a cooling means for cooling the product in the cooling zone.

13. The apparatus of claim 12 wherein the cooling means comprises a flow of mechanical refrigeration selected from cryogen or other cold gases.

14. A method for cooling a product comprising
providing a transport assembly inside a housing adapted for continuously transporting the product to be cooled into and out of the cooling zone, the assembly comprising an inlet assembly for delivering food products for processing, an outlet assembly for discharging food products for subsequent processing, an intermediate assembly disposed for coaction with the inlet assembly and the outlet assembly to provide a processing zone without suspending movement of the inlet assembly and the outlet assembly.
delivering the product to the inlet assembly for processing;
cooling the product in the cooling zone; and
removing the product from the outlet assembly.

15. The method of claim 14 wherein the cooling comprises directing a flow of mechanical refrigeration onto the product.

16. The method of claim 15 wherein directing the flow of mechanical refrigeration comprises directing the flow of a cryogen or other cold gases.

17. The method of claim 14 further comprises processing of the food product after removing the food product from the outlet assembly.
